(19) United States
(12) Patent Application Publication
(10) Pub. No.: US 2009/0126205 A1
(43) Pub. Date: May 21, 2009

(54) Saw Blade With Round Cutting Edges

(75) Inventors: Jorg H. Kullmann, Spangenberg (DE); Werner Kwanka, Vellmar (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WIKUS-Sagenfabrik Wilhelm H. Kullmann GmbH & Co. KG, Spangenberg (DE)

(21) Appl. No.: 12/269,957

(22) Filed: Nov. 13, 2008

(30) Foreign Application Priority Data
Nov. 15, 2007 (DE) 10 2007 054 600.0

(51) Int. Cl. B26B 9/00; B26B 9/02

(52) U.S. Cl. 30/347; 30/355

(57) ABSTRACT

A saw blade (1) includes a base body (2) and a plurality of teeth (3). The base body (2) defines a longitudinal center plane (14). The teeth (3) are designed and arranged to be unset and to be symmetric with respect to the longitudinal center plane (14). The teeth (3) are designed and arranged to form at least one group of teeth (3) on the base body (2). The at least one group of teeth (3) is repeated on the base body (2). The group of teeth (3) includes at least a first tooth (3₁) and a second tooth (3₂). The first tooth (3₁) includes a first cutting edge (10₁) being designed and arranged such that at least a portion of the first cutting edge (10₁) is designed to be rounded and to have at least one first radius (18₁). The second tooth (3₂) includes a second cutting edge (10₂) being designed and arranged such that at least a portion of the second cutting edge (10₂) is designed to be rounded and to have at least one second radius (18₂). The second radius (18₂) is different than the first radius (18₁).

### CROSS REFERENCE TO RELATED APPLICATIONS

This application claims priority to co-pending German Patent Application No. DE 10 2007 054 600.0 entitled “Sägeblatt mit einem Grundkörper und Zähnen mit Schneiden”, filed Nov. 15, 2007.

### FIELD OF THE INVENTION

The present invention generally relates to a saw blade including a base body and a plurality of unset teeth being designed and arranged to be symmetric to a longitudinal center plane through the base body. The teeth are arranged in at least one repeating group of teeth.

The saw blade includes an elongated base body, meaning it is designed as a saw band including a plurality of teeth. For example, the elongated base body and the teeth may be made of a bimetallic strip. However, the elongated base body may also include seats serving for arrangement of form bodies being made of hard metal. Usually, such seats are produced on the elongated base body by milling. The form bodies of hard metal are produced as separate elements, and they are then permanently connected to the seats of the elongated base body. Such a saw blade preferably is used for cutting metal, for example for cutting profiles made of steel, aluminum and the like into sections.

### BACKGROUND OF THE INVENTION

A saw blade is known from German Patent Application No. DE 42 00 423 A1 corresponding to U.S. Pat. No. 5,477,763 and U.S. Pat. No. 5,425,296. The known saw blade serves for cutting metal. It includes a base body including unset teeth having cutting portions, the teeth being arranged in repeating cycles. The teeth may be made of form bodies being made of hard metal and being connected to the base body. Each cycle includes at least a group of teeth including at least three teeth, the group of teeth including teeth of different heights and widths. All teeth are designed to be symmetric with respect to the longitudinal center plane extending through the base body. The teeth include geometrically defined cutting portions, meaning each tooth includes its own geometrically defined shape including a rake angle, a clearance angle, and so forth. The effective cutting portions of all teeth are each formed by a cutting edge the inner section of which extends approximately perpendicular to the longitudinal center plane. Bevels being declined towards the base body are arranged next to the inner section in a symmetric arrangement. In this way, the cutting edge includes corners in the region of the deviated cutting edge as well as in the transition region between the bevel and the flank. The shape of the cutting edges at each tooth may be changed by increasing the number of the deviation points. The shape of the cutting edges may be changed by increasing the number of deviation points such that one theoretically attains a rounded cutting edge when using an infinite number of deviation points.

Another saw blade is known from German Patent Application No. DE 43 00 622 A1 corresponding to U.S. Pat. No. 5,477,763 and U.S. Pat. No. 5,425,296. The known saw blade also serves for cutting metal. The teeth are arranged in repeating cycles. Each cycle includes at least one group of teeth including at least two teeth. The two teeth have different heights and widths, and they form a first group of teeth the effective cutting edge of which is formed by a deviated line. There also is a second group of teeth. The second group of teeth has the identical design. The teeth of the second group of teeth are the ones having the greatest width and the smallest height. All teeth of the second group of teeth have a continuous deviated cutting edge and rounded corners in a transition region to the flanks, the rounded corner processing the cutting channel. The shape of the cutting edges may be changed by increasing the number of deviation points such that one theoretically attains a rounded cutting edge when using an infinite number of deviation points.

Another saw blade is known from German Patent Application No. DE 199 63 396 A1 corresponding to US Patent Application No. US 2001/0004860 A1. The known saw blade is used for cutting metal. The number of tooth in one cycle is at least two. The teeth may be formed by form bodies of hard metal being connected to the base body. The two teeth form a first group of teeth, and they are designed and arranged to have different heights and widths. An effective cutting edge in the form of a deviated line is formed at each tooth. There is a second group of teeth, the teeth having straight continuous cutting edges extending over the width. The teeth of the second group of teeth are designed to be identical. The teeth of the second group of teeth are the teeth having the greatest width and the smallest height. The teeth of the first group of teeth and of the second group of teeth may be arranged in an alternating way.

Another saw blade is known from German Patent Application No. DE 44 23 434 A1 corresponding to U.S. Pat. No. 6,314,854 B1. Various embodiments of saw blades are shown in this document. The common feature of all embodiments is the fact that the flanks of the teeth have a convex arc-like shape. The configuration of the teeth according to FIG. 1 is such that the saw blade includes a base body and unset teeth being symmetric to a longitudinal center plane through the base body. The teeth all have the same design, and they are arranged on the base body without a repeating group of teeth. The effective cutting edges and portions of the cutting edges, respectively, of all teeth are all formed by a deviated cutting edge of a straight portion. The inner portion of the straight portion is located approximately perpendicular to the longitudinal center plane. A bevel being declined in an outer direction towards the base body is connected to the inner portion. Thus, the cutting edge includes corners in the region of the deviated cutting edge as well as in the transition region between the face and the flank. Another embodiment illustrated in FIGS. 2 and 3 is a saw blade including a base body and unset teeth which are arranged to be non-symmetric to a longitudinal center plane through the base body. The teeth are located in a repeating group of teeth, each group of teeth including two teeth. The cutting edges of these teeth are designed in the sense of a leading tooth and a trailing tooth. The teeth are eccentrically subjected to forces during sawing as this is the case in a similar way when using said teeth. The teeth are designed and arranged in a non-symmetric way. The non-symmetric structure of two adjacent teeth is realized in a mirror-inverted way with respect to the longitudinal center plane. The cutting edges are designed to be hyperbolic or parabolic. It is desired that the transition between the cutting edge and the flank is smoothed. Such saw blades are especially used for sawing plastic in a way to realize minimum sawing lines and to also minimize breaking effects of the corners of the material to be cut.

A saw blade including grazed teeth of hard metal is known from U.S. Pat. No. 3,169,435. The teeth are unset, they include bevels and they are arranged symmetric with respect to a longitudinal center plane through the base body. The teeth are arranged in repeating groups of teeth including two teeth in the known arrangement of a leading tooth and a trailing tooth. The first kind of teeth is active in the middle portion, while the other kind of teeth is active in the two corner portions. The teeth have different heights. All teeth have the identical width. The cutting edges of all teeth are formed by straight cutting edge portions. Each cutting edge portion is connected to an adjacent cutting edge portion by an intermediate arrangement of a deviation point and a corner, respectively.

### SUMMARY OF THE INVENTION

The present invention relates to a saw blade including a base body and a plurality of teeth. The base body defines a longitudinal center plane. The teeth are designed and arranged to be unset and to be symmetric with respect to the longitudinal center plane. The teeth are designed and arranged to form at least one group of teeth on the base body. The at least one group of teeth is repeated on the base body. The group of teeth includes at least a first tooth and a second tooth. The first tooth includes a first cutting edge being designed and arranged such that at least a portion of the first cutting edge is designed to be rounded and to have at least one first radius. The second tooth includes a second cutting edge being designed and arranged such that at least a portion of the second cutting edge is designed to be rounded and to have at least one second radius. The second radius is different than the first radius.

It is a new perception of this application that portions of the cutting edge which are theoretically ineffective during cutting can also wear out. It has been found out that the occurring wear actually does not substantially differ between effective and ineffective cutting edge portions, but wear can be determined substantially over the entire length of the cutting edge of each tooth.

A possible explanation for this phenomenon is the fact that a system of a saw blade and a sawing machine is comparatively unstable. The saw blade is only guided in a limited way with respect to the work piece such that the saw blade fulfills an avoiding movement in the sense of leaving its straight guided direction. Such avoiding movements can occur at teeth just entering the surface of the work piece or at teeth which are just intended to enter the surface of the work piece, respectively. The saw band may also be deflected from the work piece in a direction against its feed such that one or more teeth in the group of teeth do not cut. Due to the progressive feed one of the teeth in the group of teeth will enter the surface of the work piece at a particular time. The tooth will then produce and remove, respectively, a chip being greater than the chip the respective tooth should theoretically remove from the cutting channel in a strip-like shape. This thicker chip has a greater width than the theoretical chip being strip-like. This explains why such a tooth also operates with cutting edge portions which are theoretically ineffective. Due to the temporarily increased load, there is increased wear of the cutting edge which may lead to crumbling or breaking of portions of the cutting edge. These defects are overcome by the novel saw blade.

The novel saw blade includes a base body and unset teeth being arranged symmetric to the longitudinal center plane through the base body and to be located in at least one repeating group of teeth. It is also possible to use a plurality of groups of teeth or to arrange additional single teeth on the saw blade. This may result in cycles being realized. The at least one group of teeth includes at least two teeth having rounded cutting edges or at least portions of the cutting edges which are rounded. The teeth are designed and arranged to have different heights. Such different heights are to be understood such that two or more following teeth in the group of teeth have different heights as seen in the projection against the moving direction of the saw blade. This especially refers to different heights of the teeth in the longitudinal center plane. However, such different heights are also to be understood as relating to two or more following teeth in the group of teeth having identical heights in the longitudinal center plane, but including portions outside of the longitudinal center plane over the width of the teeth in which the cutting edge portions of the teeth have different heights. It is possible to also design and arrange the teeth to have different widths. The at least two teeth of the group of teeth may also have different widths in a way that the tooth having the greatest height at the same time has the smallest width. The at least two teeth in the group of teeth, but also all teeth of the saw blade may also have the same width. The teeth are unset, and they are subjected to forces during sawing, the forces being symmetric to the longitudinal center plane. In this way, deflection of the teeth as it is known in combination with set teeth is effectively prevented.

Each of the at least two teeth in the group of teeth includes a rounded or round cutting edge or at least a cutting edge of which a portion is rounded or round. The term “cutting edge” designates the entire cutting edge between the flanks of the tooth. The term “cutting edge portion” is to be understood as a part of this cutting edge. The “rounded” shape is the shape of the cutting edge or of the cutting edge portion which is to be seen in a view against the direction of movement of the saw band and perpendicular to the face of the tooth. The at least partly rounded cutting edge of the at least two teeth in the group of teeth are designed to be round, but to have different radiuses. The at least partly rounded cutting edge of the tooth is formed by at least one first radius and the at least partly rounded cutting edge of the other tooth of the group of teeth is formed by at least one second radius being different than the first radius. The saw blade may only include one repeating group of teeth including two teeth, especially in a way according to the known leading tooth and trailing tooth arrangement. However, the saw blade may also include additional single teeth in the group of teeth or outside of the group of teeth. The saw blade may also include a plurality of groups of teeth with our without introduced single teeth.

The cutting edge of one tooth in the group of teeth including at least two teeth may be designed to be a connection of two different radiuses. The two different radiuses are connected to one another, and they form at least a substantial portion of the cutting edge. The transition between the two radiuses is designed in a way to prevent a corner, or to prevent it at least as much as possible. When the two radiuses of a cutting edge or of a cutting edge portion are connected in a tangential direction, there is no corner at all. It makes sense if the cutting edges of all teeth of the group of teeth include at least two radiuses. The broadest tooth in the group of teeth determines the surface quality of the work piece in the cutting channel. It is preferred if this broadest teeth does not include corners in an outer direction, meaning in the transition region to the flank. Sharp corners or deviation points with an angle of substantially less than 180°, for example approximately 120° and less, are intended to be prevented.

The two radiuses of the cutting edge of a tooth being rounded and preventing a corner preferably are connected in a way that the connection extends in a tangential direction.

The rounded cutting edge of one tooth of the group of teeth may be connected to the flanks of the tooth in a tangential direction. This is especially preferred for the tooth of the group of teeth having the greatest width. However, this design is also advantageous for the other tooth of the group of teeth since it results in wear being reduced and thus increasing the usable lifetime of the saw blade.

At least one tooth in the group of teeth may be designed in the region of the tooth back to include a clearance surface being rounded in one direction and being convex in the other direction.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first exemplary embodiment of the novel saw blade.

FIG. 2 is a view of a first exemplary embodiment of the tip portions of the teeth of the novel saw blade as seen in a direction against the moving direction of the saw blade.

FIG. 3 is a view of a second exemplary embodiment of the tip portions of the teeth of the novel saw blade as seen in a direction against the moving direction of the saw blade.

FIG. 4 is a view of a third exemplary embodiment of the tip portions of the teeth of the novel saw blade as seen in a direction against the moving direction of the saw blade.

FIG. 5 is a view of a fourth exemplary embodiment of the tip portions of the teeth of the novel saw blade as seen in a direction against the moving direction of the saw blade.

FIG. 6 is a side view of a second exemplary embodiment of the novel saw blade.

FIG. 7 is a view of a projection of a first exemplary embodiment of three teeth in the group of teeth in the region of the cutting edges.

FIG. 8 is a view of a projection of a second exemplary embodiment of three teeth in the group of teeth in the region of the cutting edges.

FIG. 9 is a view of a first exemplary embodiment of a tooth in the region of the cutting edge as seen in a direction against the moving direction of the saw blade.

FIG. 10 is a view of a second exemplary embodiment of a tooth in the region of the cutting edge as seen in a direction against the moving direction of the saw blade.

FIG. 11 is a view of a third exemplary embodiment of a tooth in the region of the cutting edge as seen in a direction against the moving direction of the saw blade.

FIG. 12 is a view of a projection of a third exemplary embodiment of three teeth in the group of teeth in the region of the cutting edges.

FIG. 13 is a perspective view of an exemplary tooth.

FIG. 14 is a sectional view of the tooth according to line XIV-XIV in FIG. 13.

FIG. 15 is a view of a projection of a fourth exemplary embodiment of three teeth in the group of teeth in the region of the cutting edges.

FIG. 16 is a view of a projection of a fifth exemplary embodiment of three teeth in the group of teeth in the region of the cutting edges.

### DETAILED DESCRIPTION

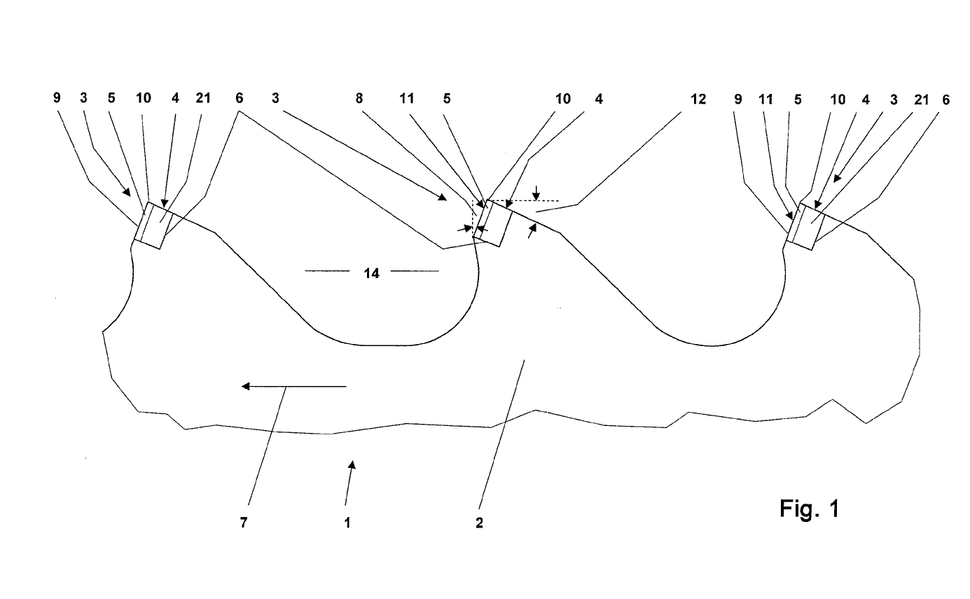

Referring now in greater detail to the drawings, FIG. 1 illustrates a first exemplary embodiment of a novel saw blade 1. The novel saw blade 1 is only partly illustrated in FIG. 1. It includes an elongated base body 2 having a known rectangular cross-section. One of the sides of the base body 2 includes teeth 3. The teeth 3 are designed and arranged to be unset and to be symmetric with respect to a longitudinal center plane 14 of the base body 2. The teeth 3 have a greater width than the base body 2. The teeth 3 are formed by form bodies 4. The greater part of each form body 4 is made of a carrier 21 being made of hard metal, and it includes a layer 5 being located at one side or one surface of the carrier 21. The layer 5 may be made of a material which is as hard or as preferably harder than the hard metal of the carrier 21. Preferably, the layer has a hardness of at least 5,000 HK (Knoop hardness). The form bodies 4 including the layers 5 are inserted and located, respectively, in seats 6. The seats 6 as well as the remaining shape of the elongated base body 2 on the side on which the teeth 3 are located preferably is produced by milling. The form bodies 4 are permanently connected to the material of the base body 4 at the seats 6, for example by welding, soldering or brazing. The seats 6 may have a shape such that each form body is positively engaged and kept in place in two directions. It is to be understood that insertion of the form bodies 4 is realized in a way that the layers 5 of the teeth 3 are directed to face in the moving direction 7 of the saw blade 1. It is also to be seen in FIG. 1 that the form body 4 forming the teeth 3 are arranged at a negative rake angle 8. The rake angles 8 of all teeth may be designed to be identical. However, it is also possible that the negative rake angles 8 vary from tooth 3 to tooth 3 such that groups of teeth, for example including three teeth 3, are formed, the negative rake angle 8 being repeated for the respective teeth 3 in each of the groups. Especially, the negative rake angle 8 is approximately −25° and 0°.

It is also to be seen in FIG. 1 that the teeth 3 may be arranged at a varying division, meaning at different distances with respect to one another. The teeth 3 are also designed and arranged to have different heights and widths. Each tooth 3 at the free surface of the layer 5 includes a face 9 being connected to a cutting edge 10 and ending in the cutting edge 10, respectively. The upper part of the face 9 and the cutting edge 10 together form a cutting portion 11. The form bodies 4 forming the teeth 3 are arranged at a clearance angle 12.

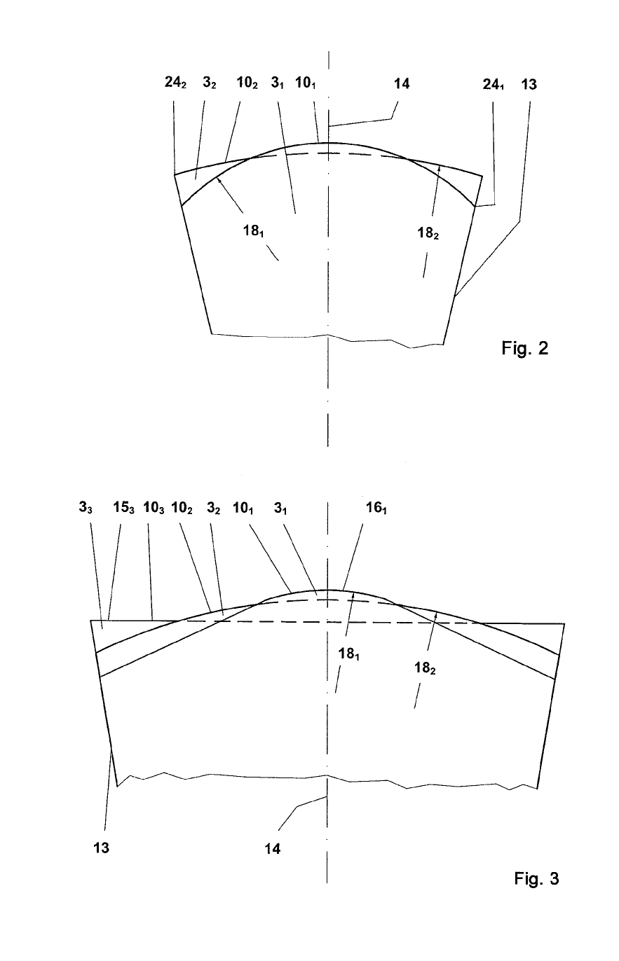

FIG. 2 illustrates the design of two teeth 3₁ and 3₂ in the group of teeth 3, meaning a design according to the leading tooth and trailing tooth technique. The tooth 3₁ includes a cutting edge 10₁ being rounded in an arcuate shape, the cutting edge 10₁ being formed by a radius 18₁. The cutting edge 10₁ is designed to be rounded over its entire extension between the flanks 13, meaning it does not include any corners, deviation points and the like. Only the end points of the cutting edge 10₁ are formed by corners 24₁. The tooth 3₂ includes a cutting edge 10₂ being rounded in an arcuate shape, the cutting edge 10₂ being formed by a radius 18₂. The cutting edge 10₂ is designed to be rounded over its entire extension between the flanks 13, meaning it does not include any corners, deviation points and the like. Only the end points of the cutting edge 10₂ are formed by corners 24₂. The two radiuses 18₁ and 18₂ are designed to be different. The center points of both radiuses 18₁ and 18₂ are located on the longitudinal center plane 14. The two teeth 3₁ and 3₂ in the group of teeth 3 have the differing radiuses 18¹ and 18₂ when observing the same location as seen over the width of the teeth 3, for example the location in the longitudinal center plane 14. The radius 18₂ is greater than the radius 18₁. Generally, the radius is increased from one tooth 3 to the next tooth 3. However, it is also possible that the radius is increased from one tooth 3 to another tooth 3 not being located adjacent to the first tooth 3. In this design of a leading tooth and a trailing tooth, it is possible to realize varying heights and widths, as this is illustrated. However, it is also possible to only use varying heights of the teeth 3.

FIG. 3 illustrates the design of a novel saw blade 1 including three teeth 3₁, 3₂ and 3₃ in the group of teeth 3. The tooth 3₁ has a cutting edge 10₁ including an arc piece 16₁ in the middle portion and straight portions being arranged at both sides in a direction towards the flanks 13. This means that only a portion of the cutting edge 10₁ is designed to be rounded. This portion of the cutting edge 10₁ has a radius 18₁. The tooth 3₂ has a cutting edge 10₂ being designed to have the radius 18₂ over its full extension. The two radiuses 18₁ and 18₂ are different. The center points of both radiuses 18₁ and 18₂ are located on the longitudinal center plane 14. The two teeth 3₁ and 3₂ in the group of teeth 3 have the differing radiuses 18¹ and 18₂ when observing the same location as seen over the width of the teeth 3, for example the location in the longitudinal center plane 14. This also applies to any teeth 3 in the group of teeth, for example the teeth 3₂ and 3₄ in a group of four adjacent teeth 3. The tooth 3₃ has a cutting edge 10₃ being formed by a straight piece 15₃ extending over the entire width. The tooth 3₃ is not designed to be rounded. The tooth 3₃ may be once located in the group of teeth 3 including three teeth 3. However, it may also be located twice in a group of teeth 3 including four teeth 3, especially in an interlaced way, meaning after each tooth 3 having an at least partly rounded cutting edge 10. However, it is not necessarily required to arrange the tooth 3₃.

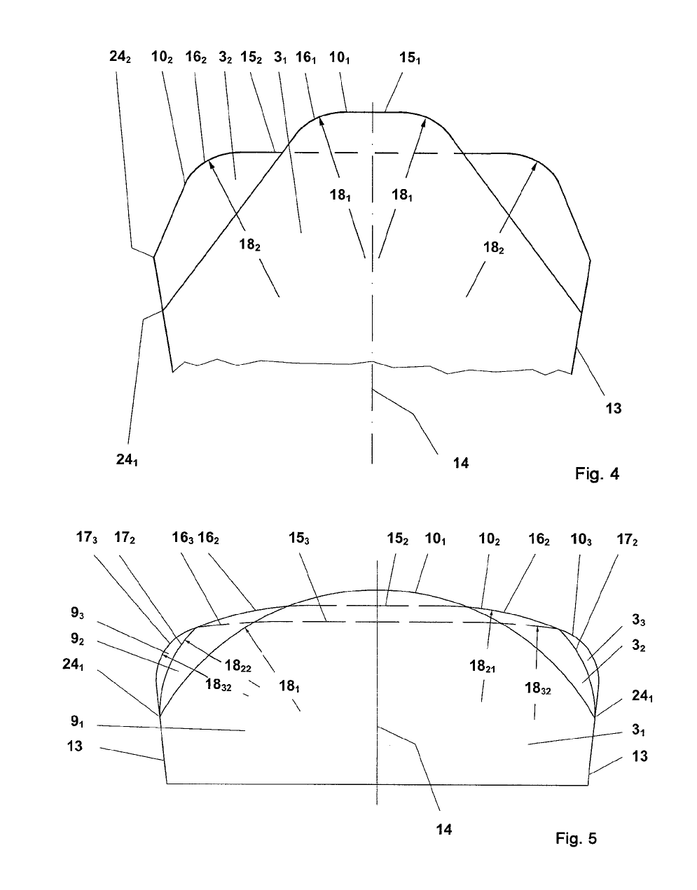

FIG. 4 illustrates an exemplary design of two teeth 3₁ and 3₂ in the group of teeth 3, meaning in accordance with the known technique with a leading tooth and a trailing tooth. The tooth 3₁ includes a cutting edge 10₁ including a straight piece 15₁ being located in the center region, two arc pieces 16₁ and two straight pieces being connected to the flanks 13 by the corners 24₁. The arc pieces 16₁ of the cutting edge 10₁ are designed to be rounded, and they have the radius 18₁. The tooth 3₂ includes a cutting edge 10₂ including the straight piece 15₂ being located in the center, two arc pieces 16₂ and two pieces being connected to the flanks 13 by corners 24₂. The arc pieces 16₂ of the cutting edge 10₂ are designed to be rounded, and they have the radius 18₂. The center points of the two radiuses 18₁ and 18₂ are located on the longitudinal center plane 14. The two teeth 3₁ and 3₂ in the group of teeth 3 have the identical indefinitely great radiuses when observing the same location as seen over the width of the teeth 3, for example the location in the longitudinal center plane 14. When observing different locations over the width of the teeth 3, the two teeth 3₁ and 3₂ have different radiuses 18₁ and 18₂. The arc pieces 16₁ and 16₂ with their radiuses 18₁ and 18₂ are connected to the straight pieces in a tangential direction such that corners or deviation points are prevented over the entire extension of the cutting edges 10₁ and 10₂. In this design of a leading tooth and a trailing tooth, it is possible to realize varying heights and widths, as this is illustrated. However, it is also possible to only use varying heights of the teeth 3. It is also possible to arrange additional teeth 3 in the group of teeth 3, the additional teeth 3 having any design.

FIG. 5 illustrates the design of the upper portions of three teeth 3 in a group of teeth 3 as seen in their projection in a direction against the direction of movement 7 of the saw blade 1. There is a tooth 3₁ being followed by a second tooth 3₂ being followed by a third tooth 3₃ as seen in a direction against the direction of movement 7 of the saw blade 1. It is to be seen that the group of teeth 3 includes three teeth 3, meaning the teeth 3₁, 3₂ and 3₃. This group of teeth 3 is repeated along the saw blade 1.

It is also to be seen in FIG. 5 that the tooth 3₁ has a face 9₁ in its upper end portion being connected to a cutting edge 10₁. The cutting edge 10₁ has the radius 18₁, and it is designed to have the shape of an arc, and it is connected to the flanks 13 at the right hand side and at the left hand side by a corner 24₁. The corner 24₁ may coincide with respective corners of different teeth 3 as seen in the projection. The flanks 13 and the associated flank angles of all teeth 3₁, 3₂ and 3₃ are identical.

The following tooth 3₂ also includes a cutting edge 10₂. The shape of the cutting edge 10₂ includes a plurality of radiuses 18₂₁ and 18₂₂ such that it attains the illustrated rounded shape. In the center portion, meaning next to the longitudinal center plane 14, the cutting edge 10₂ includes a straight piece 15₂. An arc piece 16₂ is connected to the straight piece 15₂ at both sides, the arc pieces 16₂ having the finite radius 18₂₁. Each arch piece 16₂ is connected to another arc piece 17₂ having the radius 18₂₂. The arc pieces 16₂ and 17₂ have different radiuses 18₂₁ and 18₂₂. The transition between the arc pieces 16₂ and 17₂ is realized by a common tangent. The arc piece 17₂ is connected to the flank 13 almost without a corner or a deviation point.

The third tooth 3₃ in the group also has a rounded cutting edge 10₃. The cutting edge 10₃ includes a straight portion 15₃ and two arc pieces 16₃ and 17₃. The arc piece 16₃ has the radius 18₂₁. The arc piece 17₃ is arranged in a way and it has such a radius 18₃₂ that it is connected to the flank 13 in a tangential direction. There is no corner or deviation point even in the transition region between the cutting edge 10₃ and the flank 13. The transition is located slightly below the place where the tooth 3₃ has its greatest width. The tooth 3 is designed to be broader than the teeth 3₁ and 3₂. At least one of the teeth 3₁, 3₂ and 3₃ has such a shape as it has been described with respect to the tooth 3₃. However, it is also possible that all teeth 3 in the group of teeth 3 are designed in this way. The center point of the radius 18₁ is located on the longitudinal center plane 14. The center points of the radiuses 18₂₁ and 18₂₂, on the one hand, and the center points of the radiuses 18₃₁ and 18₃₂, on the other hand, may also be located on the longitudinal center plane 14 or at a different place. However, it is preferred to design and arrange the teeth 3 such that the cutting edge and the portion of the cutting edge, respectively, is arranged symmetric with respect to the longitudinal center plane 14 to realize force engagement acting on each single tooth 3 during sawing, the force engagement taking place in the longitudinal center plane 14.

In case the term “tangential direction” or “tangent” is used herein, it is to be understood as indicating a direction or a tangent at least approximately being located in the plane of illustration of FIG. 5. In contrast thereto, a radial direction or a radial tangent is to be understood as indicating a direction being located in the longitudinal center plane 14 or in a plane parallel to the longitudinal center plane 14. For example, such a direction is illustrated in FIGS. 1, 6 and 14.

FIG. 5 also shows that the teeth 3₁, 3₂ and 3₃ have different heights and widths. The tooth 3₁ is the tooth 3 having the greatest height and the smallest width. The tooth 3₃ is the tooth 3 with the smallest height and the greatest width. The tooth 3₂ lies in between the teeth 3₁ and 3₃. The order of the teeth 3₁, 3₂ and 3₃ in the direction of movement 7 of the saw blade 1 is not necessarily required. The teeth 3₁, 3₂ and 3₃ may have the same or different rake angles 8. The clearance angles 12 may also vary. Preferably, each tooth 3₁, 3₂ and 3₃ only cooperates with a portion of its cutting edge 10, this portion freely protruding as seen in the projection of FIG. 5. In this way, strips of material are removed from the cutting channel as it has already been described with respect to the prior art. The design of corners or of sharp deviation points of radiuses 18 being connected to each other in the region of the cutting edge 10 is preferably prevented.

It is also possible that the embodiment illustrated in FIG. 5 does not include the third tooth 3₃. In this way, one attains an embodiment in which the teeth 3 have different heights, but an identical width. One attains another embodiment by adding the third tooth 3₃ having the same width as the other teeth 3₁, 3₂ such that all cutting edges coincide in one corner 24₁.

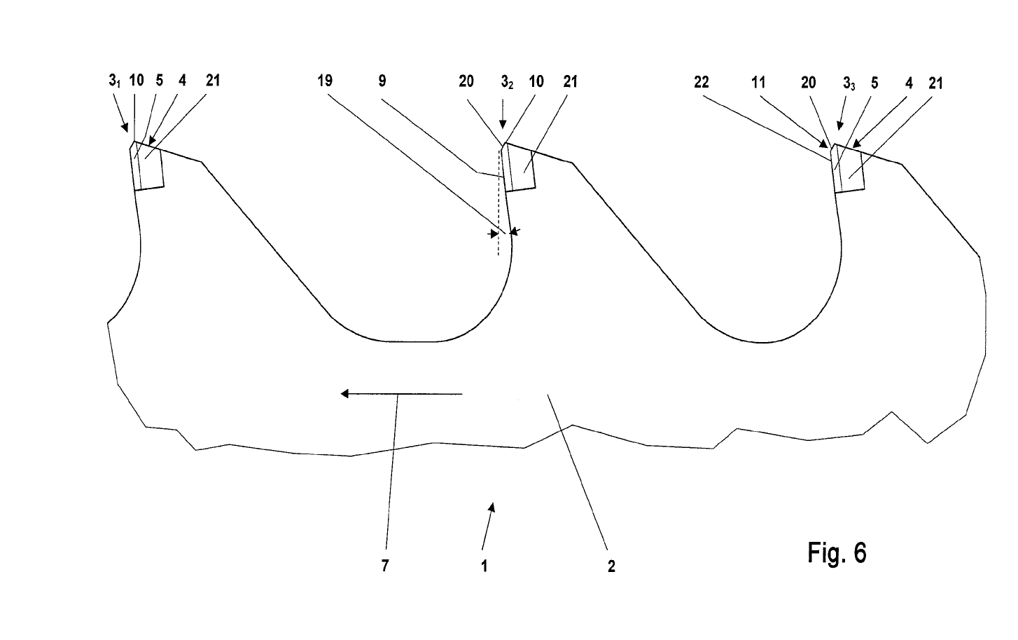

FIG. 6 illustrates another exemplary embodiment of the novel saw blade 1 including the base body 2 and three teeth 3₁, 3₂ and 3₃ being arranged in a group of teeth 3. It is to be understood that the number of teeth 3 in the group of teeth may also be more or less than 3. The teeth 3₁, 3₂ and 3₃ in this case are arranged at a positive rake angle 19. The rake angle 19 of the single teeth 3₁, 3₂ and 3₃ may be identical or different. The same applies to the division, meaning to the distances between the teeth. Each face 9 being located at a positive rake angle 19 in its upper portion is connected to a negative protecting bevel 20. The protecting bevel 20 at its highest locations is the cutting edge 10. The protecting bevel 20 extends inside of the layer 5. Due to the protecting bevel 20, one attains a negative angle in the region of the cutting edge 10.

Portions of the face 9, the protecting bevel 20 and the cutting edge 10 may include a hard material coating 22. For reasons of clarity of the drawings, this is only illustrated at the tooth 3₃. However, the coating 22 may also be arranged at the other teeth 3. Especially, the hard material coating 22 may include aluminum titanium nitride, titanium aluminum carbon nitride or chrome nitride.

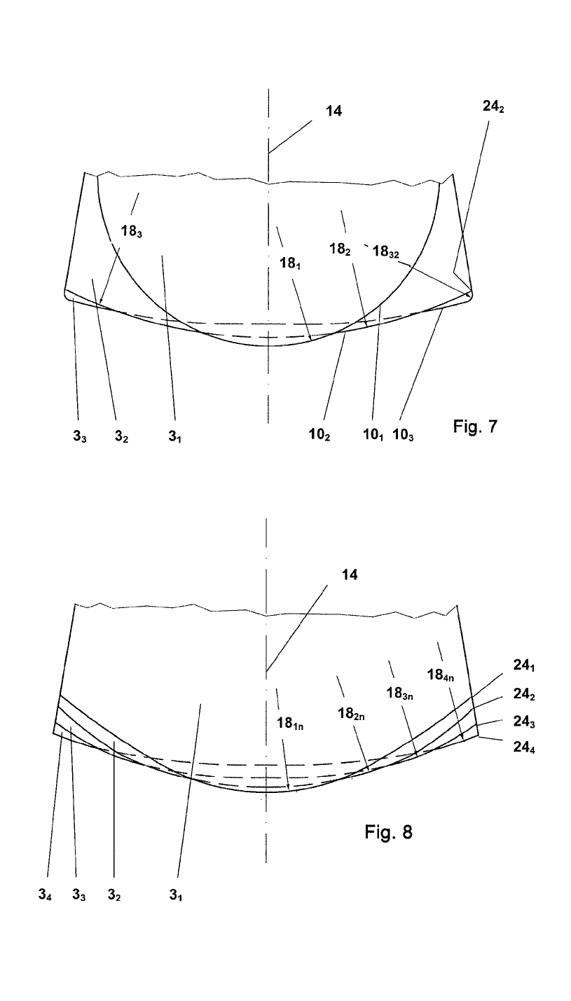

FIG. 7 illustrates a projection and a view, respectively, against the direction of movement 7 of three teeth 3₁, 3₂ and 3₃ in a group of teeth 3. The illustration is similar to the one of FIG. 5. The tooth 3₁ includes a cutting edge 10₁ having a radius 18₁. The tooth 3₂ following in the group of teeth 3 has a cutting edge 10₂ having a radius 18₂. The radiuses 18₁ and 18₂ are different. The tooth 3₃ has a cutting edge 10₃ including the two radiuses 18₃₁ and 18₃₂. The radiuses 18₃₁ and 18₃₂ are also different. The radius 18₃₂ is very small. The radiuses 18₃₁ and 18₃₂ are connected to one another in a tangential direction. The tooth 3₁ has the greatest height and the smallest width. The tooth 3₃ has the smallest height and the greatest width. The tooth 3₃ as well as the tooth 3₁ does not include a corner in the transition region with respect to the flank 13. None of the teeth 3 of the group of teeth 3 includes a corner or an edge between the flanks 13. The cutting edges 10₁, 10₂ and 10₃ are all designed to be rounded. The tooth 3₃ with its radius 18₃₂ determines the surface quality of the work piece in the cutting channel. The tooth 3₂ has an average height and width. It includes a corner 24₂. However, this corner 24₂ is located in a protected way under the projection of the section of the cutting portion 10₃ having the radius 18₃₂, and it is thus less subjected to loads. The order of the teeth 3 in the group of teeth 3 may also be different.

FIG. 8 illustrates a projection and a view, respectively, of four teeth 3₁, 3₂, 3₃ and 3₄ of a group of teeth 3. The tooth 3₁ has a cutting edge 10₁ with a series of connected different radiuses 18₁ₙ such that one attains a rounded shape with corners 24₁ being located in an outer direction. The tooth 3₂ has a cutting edge 10₂ with a series of connected different radiuses 18₂ₙ such that one attains a rounded shape with corners 24₂ being located in an outer direction. The tooth 3₃ has a cutting edge 10₃ with a series of connected different radiuses 18₃ₙ such that one attains a rounded shape with corners 24₃ being located in an outer direction. The tooth 3₄ has a cutting edge 10₄ with a series of connected different radiuses 18₄ₙ such that one attains a rounded shape with corners 24₄ being located in an outer direction. At least two radiuses 18₁ₙ and 18₂ₙ have different sizes.

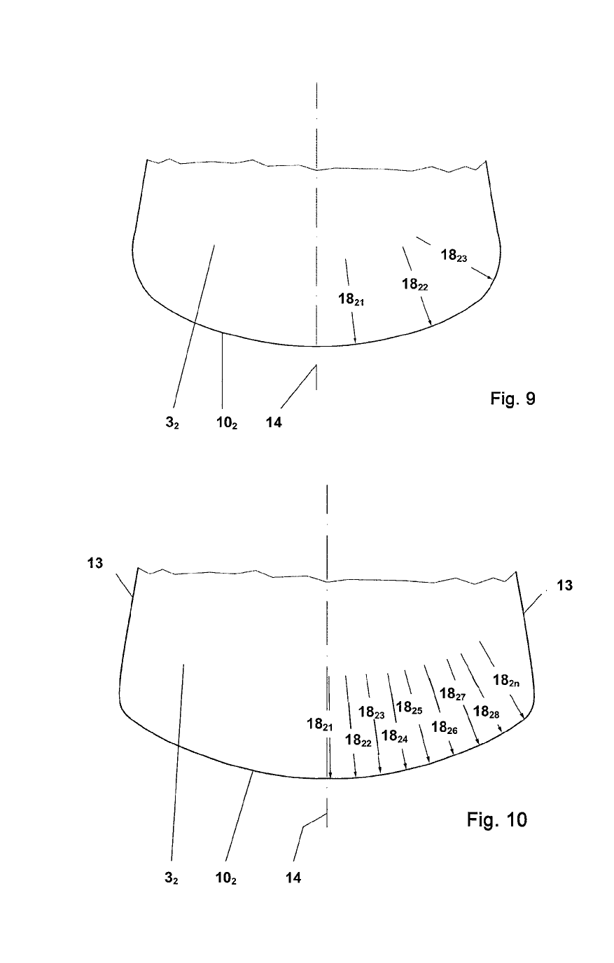

FIG. 9 illustrates a projection and a view, respectively, of a tooth 3 in a group of teeth 3 including at least two teeth 3. The tooth 3₂ includes the cutting edge 10₂ including different radiuses 18₂₁, 18₂₂ and 18₂₃. The tooth 3₂ does not include corners and sharp deviation points, respectively. The remaining teeth 3 of the group of teeth 3 may have the same design. It is possible to realize different heights and widths. However, the teeth 3 of the group of teeth 3 may also have different heights, but the same width. At least two of the radiuses 18₁ₙ and 18₂ₙ have different sizes.

FIG. 10 illustrates a projection and a view, respectively, of a tooth 3 in a group of teeth 3 including at least two teeth 3. The tooth 3₂ includes a cutting edge 10₂ including a series of different radiuses 18₂₁, 18₂₂, 18₂₃, 18₂₄, and so forth. The tooth 3₂ at its cutting edge 10₂ neither between the flanks 13 nor in the transition region with respect to the flanks 13 includes a corner or a sharp deviation point. The remaining teeth 3 of the group of teeth 3 may have the same design. It is possible to realize different heights and widths. However, the teeth 3 of the group of teeth 3 may also have different heights, but the same width. At least two of the radiuses 18₁ₙ and 18₂ₙ have different sizes.

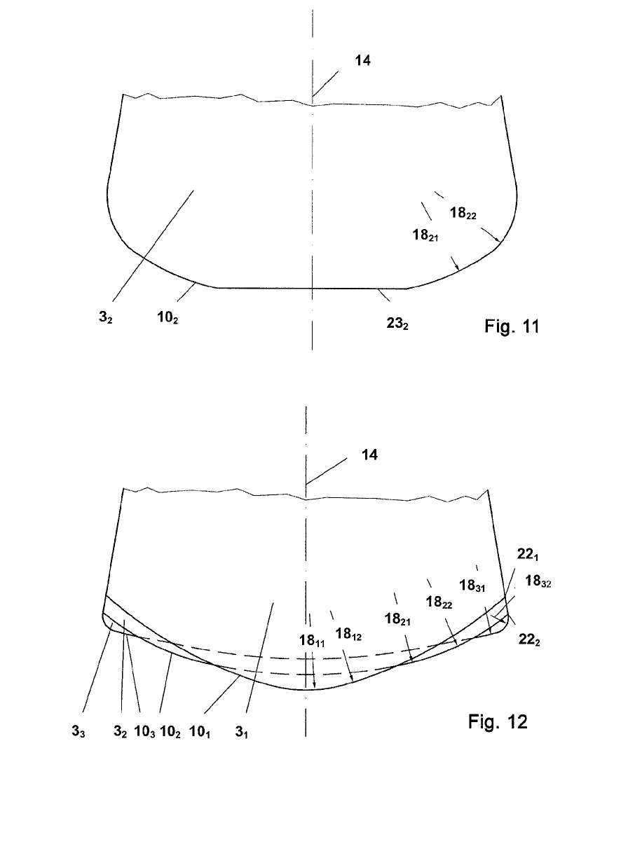

FIG. 11 is a projection and a view, respectively, of a tooth 3 of a group of teeth 3. The tooth 3₂ has a cutting edge 10₂ including a straight cutting edge portion 23₂ and a following series of two radiuses 18₂₁ and 18₂₂ being located at both sides. The tooth 3₂ does not include corners in an outer direction, meaning in a transition region with respect to the flank 13. In the other transition locations, for example between the straight cutting edge portion 23₂ and the rounded cutting edge portion being formed by the radius 18₂₁, corners are also prevented. The remaining teeth 3 of the group of teeth 3 may have the same design. It is possible to realize different heights and widths. The tooth 3₂ in the group of teeth 3 is at least combined with another tooth 3₁. The cutting edges 10₁ and 10₂ and their portions, respectively, of the two teeth 3₁ and 3₂ are formed by using two different radiuses 18₁₁ and 18₂₁.

FIG. 12 illustrates a projection and a view, respectively, of three teeth 3₁, 3₂ and 3₃ of a group of teeth 3. The tooth 3₁ includes a cutting edge 10₁ including two connected different radiuses 18₁₁ and 18₁₂ resulting in a rounded shape with corners 22₁ being located in an outer direction. The tooth 3₃ includes the cutting edge 10₃ including the connected different radiuses 18₂₁ and 18₂₂ such that one attains a rounded shape with corners 222 being located in an outer direction. The tooth 3₃ includes a cutting edge 10₃ with two connected different radiuses 18₃₁ and 18₃₂ such that one attains a rounded shape of the broadest tooth 3₃, but without corners being located in an outer direction.

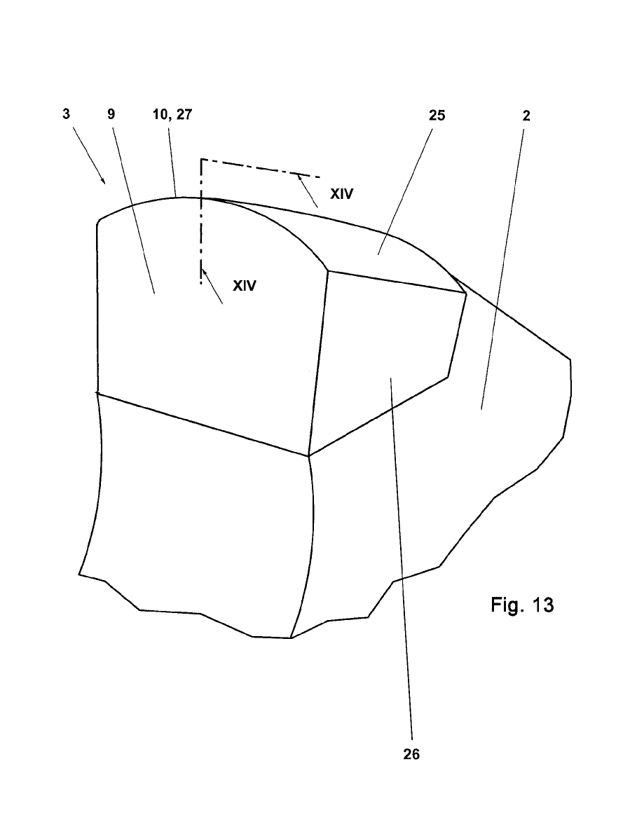

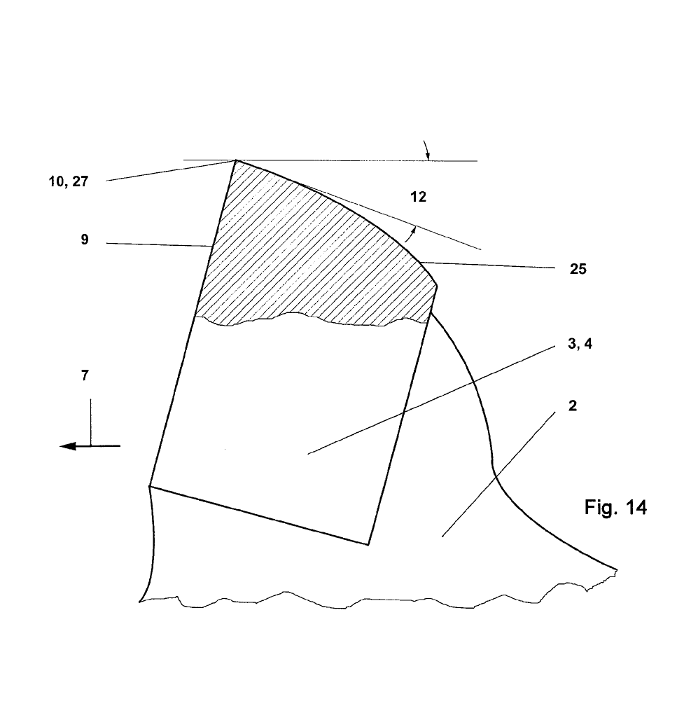

FIG. 13 illustrates a perspective view of a tooth 3 including the face 9, the cutting edge 10, the clearance surface 25 and the flank surface 26. This illustration is intended to show that the flank surface 26 is designed as a surface being plain in two directions being perpendicular with respect to one another. The clearance surface 25 is designed as a surface being convex in the direction of movement 7. This is especially clearly illustrated in the sectional view according to FIG. 14. The clearance surface 25 is also designed to be rounded in the other direction perpendicular to the longitudinal center plane 14, especially according to the shape of the cutting edge 10.

The cutting edge 10 of the tooth 3 being the transition between the face 9 and the clearance surface 25 is formed by using a cutting edge radius 27 as seen in the viewing direction. This relates to the longitudinal center plane 14 and planes being parallel thereto extending through the tooth 3. In FIG. 14, the cutting edge radius 27 is represented by a point of the cutting edge 10.

FIG. 14 illustrates a sectional view according to XIV-XIV in FIG. 13. The clearance angle 12 is indicated. The clearance surface 25 begins with the clearance angle 12 at the cutting edge 10 and at the end of the cutting edge radius 27, respectively, in a tangential direction. The free surface 25 extends in a direction against the direction of movement 7 of the saw blade 1 in a rear direction always below a plane being defined by the clearance angle 12. Due to the design of the clearance surface 25 having the convex shape, one attains that wear marks in the region of the cutting edge 10 of the tooth 3 are shorter and smaller such that the usable lifetime of the saw blade 1 is advantageously increased.

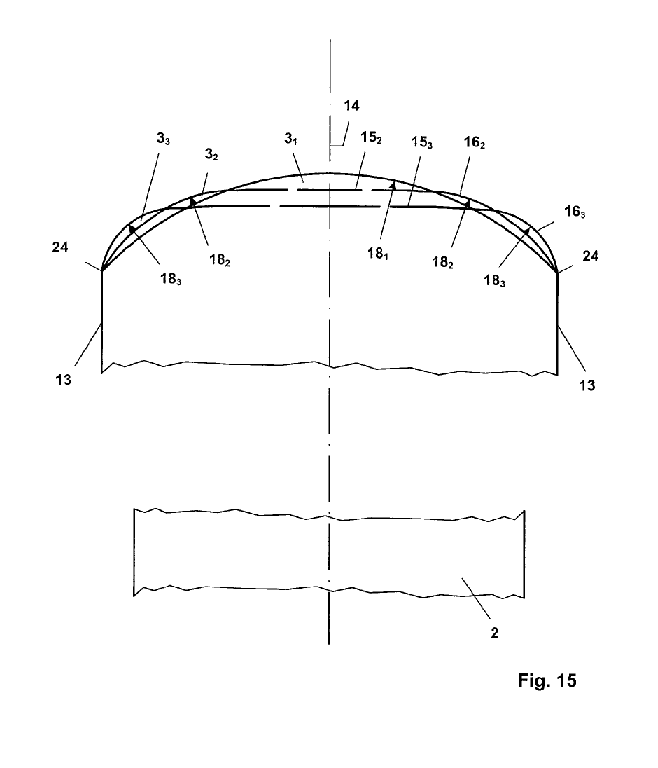

Another exemplary embodiment is illustrated in FIG. 15. FIG. 15 illustrates a flank angle of 0° which means that the flanks 13 of the teeth 3 do not only coincide in the projection, but they extend parallel to the longitudinal center plane 14. The tooth 3₁ having the greatest height is formed by only one radius 18₁ the center point of which is located on the longitudinal center plane 14. The tooth 3₂ in its center portion includes a straight piece 15₂. Cutting edge portions in the form of an arc piece 16₂ are connected to the straight piece 15₂ in a symmetric arrangement with respect to the longitudinal center plane 14. On other words, this design is also symmetric with respect to the longitudinal center plane. The tooth 3₃ in its middle portion includes a straight piece 15₃ in its middle region and arc pieces 16₃ in its outer region, the arc pieces 16₃ being formed by a radius 18₃. The center points of the two radiuses 18₂ do not have to be located on the longitudinal center plane 14. However, they are arranged to be distributed in a symmetric way with respect to the longitudinal center plane 14. The same applies to the two radiuses 18₃. The cutting edges of all teeth 3₁, 3₂ and 3₃ coincide in one common corner 24. The teeth 3 have the same width. The effective width of each tooth 3 is respectively smaller than the protruding portion in the projection such that the saw band 1 removes strips of material from the cutting channel which sum up to the entire width of the teeth 3. To make it clear that the teeth 3₁, 3₂ and 3₃ having the same width have a greater width than the base body 2, meaning that the form bodies protrude in a lateral direction, FIG. 15 also illustrates the respective portion of the base body 2. It is to be understood that the generally illustrated relationship between the width of the base body and the width of the teeth may also apply to the other designs of the cutting edges 10 of the teeth 3 illustrated in the other drawings.

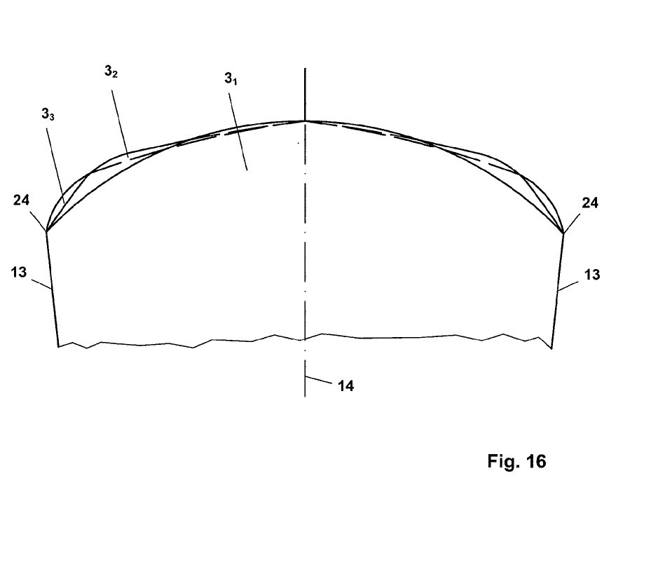

Another exemplary embodiment of the novel saw blade 1 is illustrated in FIG. 16. FIG. 16 illustrates a projection of three adjacent teeth 3 in the group of teeth 3. The cutting edges 10 of the teeth 3₁, 3₂ and 3₃ may have any design using identical or different radiuses, as this has been explained with respect to the other embodiments. The special feature of this embodiment is that all teeth 3₁, 3₂ and 3₃ have the same height and width in the longitudinal center plane 14. The different heights are only present outside of the longitudinal center plane. The shape of the cutting edge 10 at each tooth 3 may include different radiuses and arc pieces. The present invention has been explained above with reference to a rounded design of the cutting edges 10 in the sense of including at least one radius. However, it is to be understood that the radiuses may also be replaced by involutes, parabolas, hyperbolas, and so forth.

Many variations and modifications may be made to the preferred embodiments of the invention without departing substantially from the spirit and principles of the invention. All such modifications and variations are intended to be included herein within the scope of the present invention, as defined by the following claims.

We claim:

1. A saw blade, comprising:
a base body, said base body defining a longitudinal center plane; and
a plurality of teeth,
said teeth being designed and arranged to be unset and to be symmetric with respect to the longitudinal center plane,
said teeth being designed and arranged to form at least one group of teeth on said base body, said at least one group of teeth being repeated on said base body, said group of teeth including at least a first tooth and a second tooth,
said first tooth including a first cutting edge, said first cutting edge being designed and arranged such that at least a portion of said first cutting edge is designed to be rounded and to have at least one first radius,
said second tooth including a second cutting edge, said second cutting edge being designed and arranged such that at least a portion of said second cutting edge is designed to be rounded and to have at least one second radius, said second radius being different than said first radius.

2. The saw blade of claim 1, wherein at least one of said rounded portions of said cutting edges is rounded in a way that it has at least two radiuses.

3. The saw blade of claim 2, wherein said two radiuses are directly connected without an intermediate arrangement of a corner.

4. The saw blade of claim 3, wherein said two radiuses are connected in a tangential direction.

5. The saw blade of claim 1, wherein said teeth include flanks, said at least partly rounded cutting edge being designed and arranged to be connected to said flanks in a tangential direction.

6. The saw blade of claim 1, wherein said teeth include a tooth back, at least one tooth in the region of said tooth back including a clearance surface, said clearance surface being designed and arranged to be rounded in one direction and to be convex in another direction.

7. The saw blade of claim 1, wherein said teeth further include a face, a clearance surface and a cutting edge radius, said cutting edge between said face and said clearance surface being designed to be rounded and to have a cutting edge radius of between approximately 15 μm and 45 μm.

8. The saw blade of claim 1, wherein said teeth further include a face, a clearance surface and a cutting edge radius, said cutting edge between said face and said clearance surface being designed to be rounded and to have a cutting edge radius of between approximately 15 μm and 30 μm.

9. The saw blade of claim 1, wherein said teeth are designed as form bodies made of hard metal, said form bodies being permanently connected to said base body.

10. The saw blade of claim 1, wherein said teeth are formed by form bodies, said form bodies including a carrier being made of hard metal and a layer having a hardness of at least 5,000 HK, said carrier being permanently connected to said base body.

11. The saw blade of claim 10, wherein said layer is made at least of one of the materials selected from the group consisting of PCD and CBN.

12. The saw blade of claim 1, wherein said teeth have a rake angle of between approximately −10° and 20°, a clearance angle of approximately between 0° and 15° and a negative protecting bevel having a bevel angle of approximately between 0° and −25°.
